(19) United States
(12) Patent Application Publication
(10) Pub. No.: US 2021/0124097 A1
(43) Pub. Date: Apr. 29, 2021

(54) DIFFUSIVE STRUCTURE FOR LIGHT SOURCE

(71) Applicant: COMMISSARIAT A L'ENERGIE ATOMIQUE ET AUX ENERGIES ALTERNATIVES, Paris (FR)

(72) Inventors: Salim BOUTAMI, Grenoble Cedex 9 (FR); François TEMPLIER, Grenoble Cedex 9 (FR); Bernard AVENTURIER, Grenoble Cedex 9 (FR)

(73) Assignee: COMMISSARIAT A L'ENERGIE ATOMIQUE ET AUX ENERGIES ALTERNATIVES, Paris (FR)

(21) Appl. No.: 17/032,204

(22) Filed: Sep. 25, 2020

(30) Foreign Application Priority Data
Sep. 27, 2019 (FR) 19 10729

(51) Int. Cl. G02B 5/02; G02F 1/01; G02F 1/1343; G02F 1/137; G02B 30/26

(52) U.S. Cl. CPC G02B 5/0226; G02F 1/0136; G02B 5/0278; G02B 30/26; G02F 1/13439; G02F 1/137; G02B 5/0268

(57) ABSTRACT

The invention relates to a diffuser 3 intended to receive the light transmitted by a visible light source 1 comprising a transmission layer 10 and a diffusion layer 22 intended to diffuse said light, the diffuser being characterised in that the diffusion layer comprises a plurality of metal nanostructures 200, each of these metal nanostructures having, in projection in a main extension plane xy, a longitudinal dimension L along a longitudinal axis and a transverse dimension l along a transverse axis, said longitudinal and transverse dimensions being different to one another and the transverse dimension l being less than 650 nm, and in that these metal nanostructures are further distributed within the diffusion layer such that at least two adjacent metal nanostructures are respectively oriented along two non-parallel longitudinal axes.

The invention also relates to a method for manufacturing such a diffuser, and a display system comprising such a diffuser.

### TECHNICAL FIELD

The invention relates to the field of optics. It has a particularly advantageous application in improving the diffusivity of pixelized light sources, such as light-emitting diodes (LEDs).

### STATE OF THE ART

A light source can be extended or point source.

A point light source, also called pixelized light source, can be used in viewing or display systems. In particular, a plurality of adjacent point light sources allows to form pixels of a screen. Such a point light source can have dimensions of the order of a few tens of microns. Light-emitting diodes (LEDs) can advantageously form these point light sources.

An LED also has a relatively restricted beam angle. It is characterised by an increased directivity.

In certain applications however, it can be necessary to have a point light source having a low directivity, with a large beam angle. It is the case for 3D display screens, for example.

A solution to make a not very directive LED consists of adding a diffusive structure to the LED, so as to diffuse the light transmitted by the LED in all directions.

In a known manner, such a diffusive structure can be presented in the form of a dielectric diffusion film comprising random dielectric corrugations (FIG. 1A). The pseudo-periods and/or the dimensions of these corrugations can reach several microns, even several tens of microns (FIG. 1A). They are, in particular, larger than the transmission wavelength of the LED.

The operation of such a dielectric diffusion film is not therefore directly based on a phenomenon of diffusing light. The dielectric diffusion film generates, in this case, multiple refractions of light on surfaces of inclinations different from the corrugations, such as illustrated in FIG. 1B. The light is therefore refracted by the diffusion film, called refractive diffusion film, in a multitude of different directions.

This phenomenon of refracting light statistically in all directions reproduces, by averaging effect, an isotropic diffusion phenomenon. This type of refractive diffusion film operates very well for extended light sources.

However, for pixelized light sources, in particular for pixelized sources of which the dimensions are less than or equal to 15 μm, this type of refractive diffusion film does not allow to reproduce an isotropic diffusion phenomenon for each of the sources.

Such pixelized sources arranged facing this type of refractive diffusion film are no longer each associated with a multitude of corrugations.

The averaging effect obtained with an extended source is therefore no longer obtained with a point source. In this case, the light transmitted by a point source is refracted in a limited number of directions, even in one single direction. The diffusion phenomenon is therefore not well reproduced. This refraction is even partially anisotropic. The point source, for example an LED forming a pixel of a display screen, remains very directive with this type of refractive diffusion film.

In this case, the refraction direction(s) further vary(ies) from one pixel to another. For a screen of which the pixels are LEDs, all transmitting a light of same luminous intensity, luminous intensity variations due to the refraction diffusion film can therefore be perceived on the screen, along the observation direction. The refractive diffusion film does not allow to obtain an isotropic diffusion of the light transmitted by a point source.

The present invention aims to overcome at least partially some of the disadvantages mentioned above.

An aim of the present invention is to propose a solution allowing to optimise the diffusion of the light transmitted by a light source, in particular by a point light source.

Another aim of the present invention is to propose a solution allowing to improve the isotropy of the diffusion.

The other aims, features and advantages of the present invention will appear upon examining the following description and supporting drawings. It is understood that other advantages can be incorporated.

### SUMMARY

To achieve the aims mentioned above, the present invention provides, according to a first aspect, a diffuser intended to receive the light transmitted by a visible light source, said diffuser comprising a transmission layer and a diffusion layer, preferably supported by the transmission layer, and intended to diffuse the light transmitted by the light source.

Advantageously, the diffusion layer comprises a plurality of metal nanostructures.

These metal nanostructure each have, in projection in a main extension plane:
a longitudinal dimension corresponding to the largest dimension of the metal nanostructure according to this projection, the longitudinal dimension extending along a longitudinal axis and,
a transverse dimension taken along a transverse axis perpendicular to the longitudinal axis, the transverse dimension being less than the longitudinal dimension and being less than 650 nm.

These metal nanostructures are further distributed within the diffusion layer such that the longitudinal axes of at least two adjacent metal nanostructures are non-parallel to one another.

The longitudinal axis of the nanostructure is called large axis and the transverse axis of the nanostructure is called small axis.

Thus, the diffuser according to the invention comprises a plurality of nanostructures each having at least one dimension—the transverse dimension—less than 650 nm, preferably less than 500 nm, and preferably less than 400 nm. This transverse dimension is therefore less than at least one portion of the spectrum of wavelengths of the visible light. This allows to obtain a phenomenon of diffusing this light, contrary to the refractive diffuser presented above.

Moreover, these nanostructures are made of a metal material. Such a metal material has, in particular, a refraction index at least twice greater than that of the transmission layer, transparent to the light transmitted. This allows to obtain a phenomenon of significant diffusion, contrary to the refractive diffuser presented above. The effectiveness of the diffusion is improved.

The nanostructures preferably form a single layer of particles on the transmission layer. The light which passes through this single layer in normal or almost normal incidence is thus slightly attenuated. Almost all of the incident light can thus be effectively diffused.

Moreover, these nanostructures, in particular the adjacent nanostructures, between them have different orientations. This allows to avoid a diffusion of the light along a favoured direction by network effect. This allows to improve the isotropy of the diffusion. The nanostructures are preferably oriented randomly or in a disorganised manner.

Thus, the present invention provides to integrate in the diffusion layer of the metal nanostructures allowing not only to diffuse the light, but to make such an effective and isotropic diffusion.

The developments made in the scope of the present invention have shown that the combination of the features of these nanostructures allowed to obtain a synergic effect, leading to an optimised diffusion, in particular for point or pixelized light sources.

A second aspect of the present invention relates to a method for manufacturing a diffuser comprising at least one diffusion layer intended to diffuse a light transmitted by a visible light source and comprising a plurality of metal nanostructures.

This method comprises the following steps:
Providing a transmission layer made of a material transparent to the light transmitted, and having a front face,
Forming on the front face, a plurality of metal nanostructure, each of these metal nanostructures having, in projection in a main extension plane parallel to the diffusion layer, a longitudinal dimension along a longitudinal axis and a transverse dimension along a transverse axis, said longitudinal and transverse dimensions being different to one another and the transverse dimension being less than 650 nm, the metal nanostructures being further distributed within the diffusion layer, such that at least two adjacent metal nanostructures are respectively oriented along two non-parallel longitudinal axes.

A third aspect of the present invention relates to a system comprising at least one diffuser according to the invention and at least one pixelized light source, arranged to one another. The at least one diffuser is configured to cooperate with the at least one point light source so as to diffuse a light transmitted by it.

Such a system can advantageously be used to produce a display screen, in particular 3D screens.

### BRIEF DESCRIPTION OF THE FIGURES

The aims, objectives, as well as the features and advantages of the invention will emerge better from the detailed description of embodiments of the latter which are illustrated by the following supporting drawings, wherein:

FIG. 1A is an image by scanning electron microscope of a dielectric diffusion film according to the prior art.

FIG. 1B schematically illustrates, as a cross-section, an operation of the dielectric diffusion film of FIG. 1A.

FIG. 2A schematically illustrates, as a transverse cross-section, a diffuser comprising a diffusion layer, a transmission layer and a polarisation layer according to a non-limiting embodiment of the present invention.

FIG. 2B schematically illustrated, as a top view, a diffusion layer of a diffuser according to an embodiment of the present invention.

FIG. 3A schematically illustrates, as a transverse cross-section, a first configuration of a liquid crystal.

FIG. 3B schematically illustrates, as a transverse cross-section, a second configuration of a liquid crystal.

[FIG. 4A] FIGS. 4A to 4I schematically illustrate the steps of forming a diffuser comprising a diffusion layer with a basis of a plurality of metal nanostructures, a transmission layer, a polarisation layer with a basis of liquid crystals, according to an embodiment of the invention.

FIG. 5 shows an arrangement of a diffuser with a plurality of LEDs, according to an embodiment of the invention.

FIG. 6 shows a system configured for a 3D display comprising a high-resolution screen associated with a microlens array.

FIG. 7 shows a system configured to a 3D display comprising a plurality of micro-screens associated with a plurality of projection systems and with at least one diffuser, and a microlens array.

FIG. 8 shows a projection system of the 3D display system illustrated in FIG. 7, according to an embodiment.

FIG. 9 shows a sizing of a portion of the 3D display system illustrated in FIG. 7.

FIG. 10 shows the 3D display system illustrated in FIG. 7, comprising at least one diffuser according to a non-limiting embodiment of the present invention.

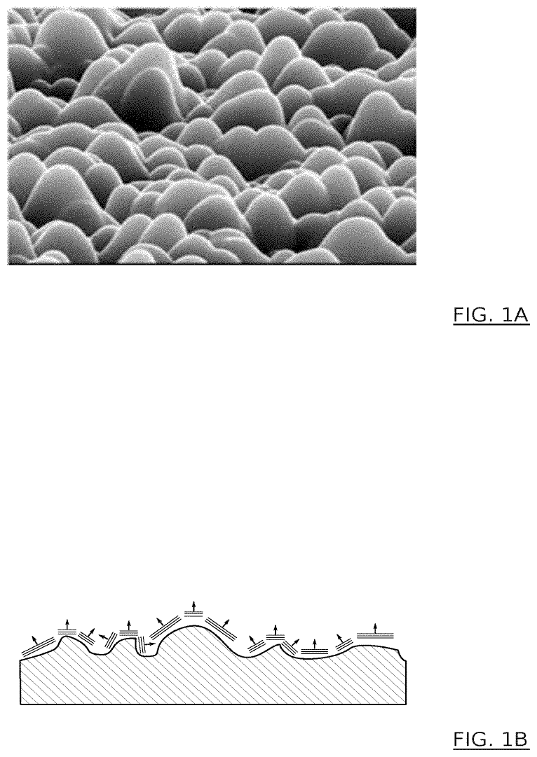

The drawings are given as examples and are not limiting of the invention. They constitute principle schematic representations intended to facilitate the understanding of the invention and are not necessarily to the scale of practical applications. In particular, the dimensions of the different layers and structures of the diffusers are not representative of reality.

### DETAILED DESCRIPTION

Before starting a detailed review of embodiments of the invention, it is reminded that the invention according to the first aspect thereof comprises, in particular, the optional features below could be used in association or alternatively.

According to an example, the longitudinal axes of the metal nanostructures are oriented along a plurality of different longitudinal orientations in the main extension plane.

According to an example, the longitudinal L and transverse l dimensions are such that L≥k*l, with k=1.5 and preferably k=2 and preferably k=3.

According to an example, for at least some of the adjacent metal nanostructures, the longitudinal axes of these adjacent metal nanostructures form an angle α of at least 40° and preferably of at least 60°.

According to an example, for a given metal nanostructure, at least several nanostructures adjacent to said given nanostructure have a longitudinal axis non-parallel to that of said given nanostructure.

According to an example, the diffuser further comprises a polarisation layer configured to polarise the light transmitted by the source and intended to be diffused by the plurality of metal nanostructures.

According to an example, the polarisation layer comprises a polariser.

According to an example, the polarisation layer comprises a liquid crystal.

According to an example, the polarisation layer is configured to dynamically modulate the polarisation of the light transmitted according to a modulation frequency.

According to an example, the modulation frequency is comprised between 20 Hz and 200 Hz.

According to an example, the longitudinal dimension is comprised between 200 nm and 2 μm, and the transverse dimension is comprised between 50 nm and 500 nm.

According to an example, the metal nanostructures have, in projection in the main extension plane, a shape taken from among an ellipse and a rectangle.

According to an example, the metal nanostructures all have the same shape.

According to an example, the diffuser has in the main extension plane, a main extension dimension D comprised between 5 μm and 30 μm.

According to an example, the metal nanostructures have a refraction index at least twice greater than that of the transmission layer.

According to an example, the diffusion layer has a thickness h comprised between 100 nm and 500 nm.

According to an example, at least some of the metal nanostructures is made of at least one metal taken from among aluminium, tungsten, copper, silver, gold.

The invention according to the second aspect thereof comprises, in particular, the optional features below which could be used in association or alternatively:

According to an example, the method further comprises a step of depositing on the plurality of metal nanostructures of a material transparent to the light transmitted and surrounding the metal nanostructures. According to an example, the method further comprises a planarisation step of the diffusion layer, configured to form a composite diffusion layer comprising the transparent material surrounding the metal nanostructures.

According to an example, the method further comprises the formation of a polarisation layer extending on a rear face of the transmission layer, said polarisation layer being configured to polarise the light transmitted by the source and intended to be diffused by the metal nanostructures.

According to an example, the formation of the polarisation layer comprises a formation of a cavity and a filling of said cavity by a liquid crystal.

According to an example, the method further comprises the formation of electrodes around the cavity, said electrodes being configured to apply an electric field to the liquid crystal and to electrically connect the polarisation layer to a modulation system configured to engage with the diffuser in order to dynamically modulate the polarisation of the light polarised by the polarisation layer, according to a modulation frequency.

According to an example, the display system comprises:
a screen, preferably with a very high resolution, comprising a plurality of micro-screens each comprising a plurality of pixels,
a plurality of projection systems associated with the plurality of micro-screens,
at least one diffuser associated with at least one pixel of the pluralities of pixels of the micro-screens, and
a microlens array associated with the at least one diffuser.

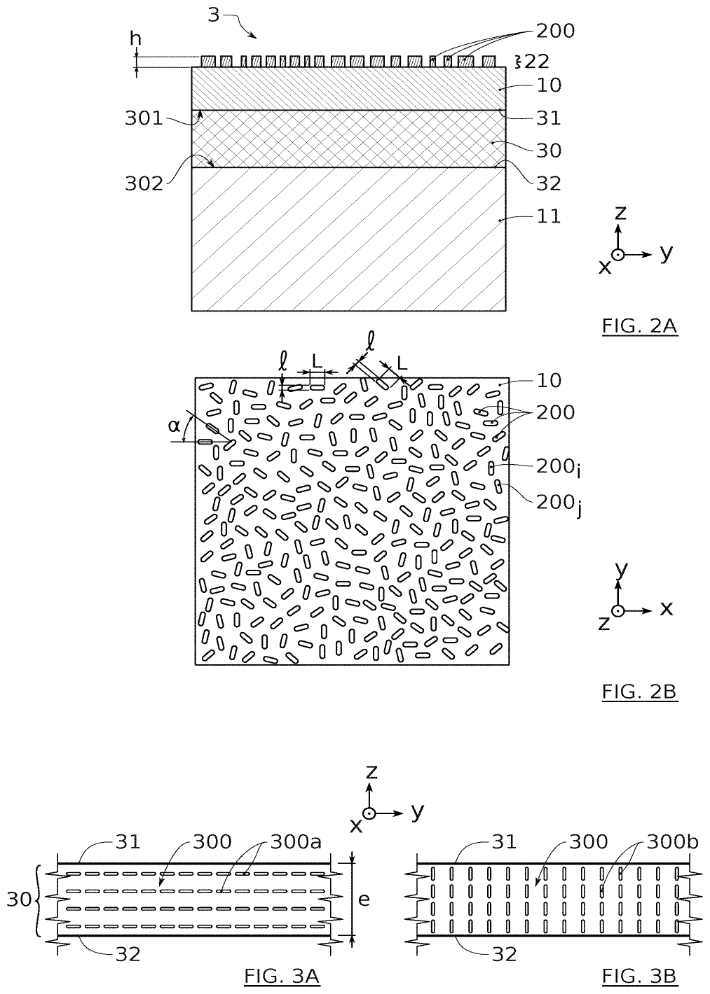

In the present patent application, reference is made to a main extension plane. This main extension plane is the plane xy of the coordinate system illustrated in FIGS. 2A, 2B, 3B and 4A, in particular.

In the present patent application, thickness will preferably be referred to for a layer and height for a device. The thickness and the height are taken along a direction z normal to the main extension plane.

The term nanostructure means, in particular, a solid object of which at least one dimension is nanometric, i.e. strictly less than 1 μm. In the scope of the invention, the nanostructures each have at least one nanometric dimension in the main extension plane less than a few hundred nanometres, that is preferably less than a wavelength of interest of the light transmitted.

In the scope of the invention, the nanostructures have a small axis and a large axis, in projection in the main extension plane, and are oriented longitudinally along the large axis thereof.

In the scope of the invention, the nanostructures have varied orientations. This means that the nanostructures are not all directed along one same direction, or along a few favoured directions only. Thus, the large axes thereof extend along different directions.

In the present invention, the diffuser is in particular intended to be arranged with point light sources, in particular, LEDs.

A point light source extends from a source having dimensions in projection in the main extension plane less than a few tens of microns, in particular less than 30 μm, and preferably less than or equal to 15 μm.

The invention can however be implemented more broadly for different light sources, for example, extended sources.

The point or extended light sources can be polychromatic or monochromatic. The light transmitted by these sources is preferably a visible light.

In the case of a polychromatic source, the wavelength of interest of the light transmitted by this source can be the smallest wavelength transmitted by the source. It can possibly be the smallest wavelength transmitted by the source and received by the diffusion layer, in the case where an intermediate element between the source and the diffusion layer (for example, a filter or the transmission layer itself) filters some of this light, intentionally or not. It can also extend from a range of wavelengths of a few tens of nanometres, for example of the order of 100 nm or less.

In the case of a monochromatic or almost monochromatic source, the wavelength of interest is the only wavelength transmitted by this source or the wavelength mainly transmitted by this source.

Unless explicitly mentioned, it is specified that, in the scope of the present invention, the relative arrangement of a third layer inserted between a first and a second layer and a second layer, does not compulsorily mean that the layers are directly in contact with one another, but means that the third layer is either directly in contact with the first and second layers, or separate from these by at least one other layer or at least one other element.

The steps of forming different layers and regions are understood in the broad sense: they can be carried out in several sub-steps which are not necessarily strictly successive.

By a material M-“based” substrate, layer, device, this means a substrate, a layer, a device comprising this material M only or this material M and possibly other materials, for example, alloy elements, impurities or doping elements. Thus, a metal nanostructure-based diffusion layer can, for example, comprise tungsten (W) nanostructures, or tungsten (W) and aluminium (AI) nanostructures, or also tungsten (W) nanostructures and a transparent encapsulation material.

By a layer or a material, “transparent to the light transmitted or to the wavelength of interest”, or simply “transparent”, this means a layer or a material letting at least 90% of the luminous intensity of the light having this wavelength of interest pass through.

The terms “substantially”, “about”, “of the order of” means “almost 10%” or, when it relates to an angular orientation, “almost 10°”. Thus, a direction substantially normal to a plane means a direction having an angle of 90±10° with respect to the plane.

To determine the geometry of the diffuser and the compositions of the different layers, optical microscope or scanning electron microscope (SEM) analyses can be proceeded with.

The chemical compositions of the different layers or regions can be determined using the well-known EDX or X-EDS (energy dispersive x-ray spectroscopy) method.

This method is well-adapted to analyse the composition of small structures such as metal nanostructures. It can be implemented on metallurgic cross-sections within a scanning electron microscope (SEM).

These techniques allow, in particular to determine if the diffuser comprises a diffusion layer comprising metal nanostructures, such as described in the present invention. Furthermore, it could be possible to observe that the metal nanostructures have large axes and small axes. Moreover, it could be possible to observe that the metal nanostructures extend along varied directions and non-parallel to one another. Naturally, other approaches will be able to be considered to determine if a diffuser, an optoelectronic device or a method reproduce the features covered by the claims.

A polarising optical microscope can further allow to highlight a polarisation layer such as described in the present invention.

A preferred embodiment of a diffuser according to the invention will now be described in reference to FIGS. 2A, 2B.

According to this embodiment, the diffuser 3 comprises a diffusion layer 22 surmounting a transmission layer 10. Preferably, and as illustrated, the diffuser 3 also comprises a transparent substrate 11 supporting the transmission layer 10 and the diffusion layer 22.

Only optionally, and as will be described below, the diffuser 3 can possibly comprise a polarisation layer 30. Preferably, this polarisation layer 30 is disposed between the substrate 11 and the transmission layer 10. The faces of each of these layers extend mainly along planes parallel to one another and parallel to the main extension plane xy of the coordinate system xyz illustrated in FIG. 2A.

The diffuser 3 in particular has a side intended to be facing the light source (not illustrated), and an opposite side intended to be facing an observer. Typically, the face 302 illustrated in FIG. 2A is intended to be rotated facing the light source and the face 301 is intended to be rotated facing the observer.

In this example illustrated in FIG. 2A, the polarisation layer 30 is situated between the transmission layer 10 and the source. Preferably, the diffusion layer 22 is situated between the transmission layer 10 and the observer.

This transmission layer 10 is made of a transparent material in the visible, in particular with wavelengths of the light to be transmitted. This transparent material can be silicon oxide-, silicon nitride-, sapphire-based.

The transmission layer 10 can form a transparent support for the diffusion layer 22 of the diffuser.

The diffusion layer 22 comprises a plurality of metal nanostructures 200, also called nanoparticles or particles. These metal nanostructures 200 are separate from one another. They are thus separated from one another.

At least some nanostructures, preferably each nanostructure resembles an elongated metal particle, in projection in the main extension plane xy parallel to the faces of the transmission layer 10. Thus, a nanostructure has in particular a longitudinal dimension or length L defined by the maximum extension dimension thereof. This longitudinal dimension extends along an axis called longitudinal axis or large axis for this nanostructure. The nanostructure also has a transverse dimension or width l which corresponds the largest dimension of the nanostructure taken along an axis perpendicular to the longitudinal axis. This transverse dimension extends along an axis, called transversal axis or small axis. Examples of length L and of width l are illustrated in FIG. 2B.

The transversal dimension (width) is less than the longitudinal dimension (length) of the nanostructure.

Preferably, all the metal nanostructures have a transversal dimension less than the longitudinal dimension thereof. However, it can be provided that, within the diffusion layer 22, certain nanostructures are not elongated and do not respond to this definition.

Preferably L≥k*l, with k=1.5 and preferably k=2 and preferably k=3.

Preferably, the transversal dimension l, i.e. the width l of the nanostructures is less than 650 nm. This width is in particular, less than the wavelengths of interest of the light to be diffused. According to a possibility, the length L of the nanostructures is also less than the wavelengths of the light to be diffused.

The nanostructures 200 can have a width l comprised between 50 nm and 500 nm, and a length L comprised between 200 nm and 2 μm. They can have a height h comprised between 100 nm and 500 nm.

These nanostructures 200 can have, in projection in the main extension plane xy, different shapes, for example ellipsoidal shapes such as represented in FIG. 2B, oblong or rectangular, or any other shape having a large axis and a small axis (for example, a diamond). These shapes are preferably identical to one another.

These metal nanostructures 200 are distributed over the transmission layer 10 randomly or in a disorganised manner (FIG. 2B). In particular, the respective large axes of these nanostructures are directed along a plurality of non-parallel directions, in the main extension plane xy.

During the operation of the diffuser, the orientation of the nanostructures does not vary. The nanostructures are fixed during the operation. They are typically fixed to the underlying transmission layer or encapsulated in an encapsulation layer. Such an encapsulation layer is not liquid or viscous. It is typically rigid.

For each nanostructure, the direction of the large axis thereof defines “the orientation” of this nanostructure. Each nanostructure typically has one single orientation.

In the case of a distribution of orientations of the narrow or Gaussian nanostructures, the formation of an organised network of nanostructures is favoured. An organised network has a high degree of order which favours certain interactions with the incident wave of the light transmitted by the source (for example, by resonance). It is what is called below, “network effect”. Consequently, the light is extracted via this organised network along certain favoured directions only. In this case, the diffusion is not isotropic.

On the contrary, a staggered distribution of orientations of the nanostructures favours the formation of a disorganised network of nanostructures. A disorganised network has a low degree of order which limits, even which removes, the network effect. Consequently, the light is extracted via this disorganised network more isotropically. The isotropy of the diffusion is improved by using such a disorganised network.

According to an advantageous possibility, the distribution of orientations of the nanostructures 200 is preferably as staggered as possible. For example, each of the nanostrucutres of the plurality of metal nanostructures has at least one adjacent metal nanostructure having an orientation different from that of the nanostructure in question. According to a possibility, only the orientations of the nanostructures are varied, and the positions of each of the barycentres of these nanostructures are situated on the nodes of an organised network.

According to a preferred possibility, the distances between the barycentres of these nanostructures are preferably also varied, so as to reduce the network effect and to consequently improve the isotropy of the diffusion. According to an example, the nanostructures do not form a periodic or regular network, or are not distributed according to a periodic or regular network.

According to an example, the longitudinal axes of the adjacent nanostructures are non-parallel. According to an example, for each nanostructure, the longitudinal axis of this nanostructure is non-parallel with the longitudinal axes of the nanostructures which are adjacent to it. According to an example, less than 5% of the nanostructures have a longitudinal axis which is parallel to one of the nanostructures which are adjacent to it.

Preferably, the angle α formed by the longitudinal axes of two adjacent metal nanostructures is of at least 40° and preferably of at least 60°.

According to a possibility, the nanostructures 200 can have varied sizes. For example, the nanostructures 200 can have varied lengths L and/or widths l. Alternatively or in a combined manner, the nanostructures 200 of one same diffusion layer 22 can have varied shapes. This also allows to reduce the network effect and to improve the isotropy of the diffusion.

The production of such a diffusion layer 22 can advantageously be done by microelectronic standard planar technologies (deposition, lithography, etching), as outlined below in the description.

It can alternatively be achieved by one single step of depositing metal nanoparticles having the features of sizes and shapes mentioned above. This deposition can be done from colloidal metal nanoparticle solutions, by gravity deposition and/or by well-known electrodeposition or electrophoresis techniques allowing to obtain a layer of nanostructures oriented randomly.

Although the nanostructures 200 are configured and disposed so as to limit to the maximum, the network effect, certain favoured diffusion directions can however subsist. Such favoured directions form the angular signature of the diffusion.

In order to remove this angular signatures and to improve the isotropy of the diffusion, the diffuser 3 advantageously provides a polarisation layer 30 intended to polarise and to modulate the polarisation of the light transmitted by the source, before diffusion of this light polarised by the nanostructures of the diffusion layer 22.

According to a possibility, this polarisation layer 30 comprises successively, starting on the source side, a polariser then a device for dynamically modulating the polarisation.

The polariser situated on the side of the source allows to polarise the light transmitted by the source. Such a polarised light can then be modulated more effectively by the modulation device than a non-polarised light.

The dynamic modulation device is preferably based on one or more liquid crystals. In a known manner, a liquid crystal has anisotropic properties. The molecules which compose it have, in particular, a small axis and a large axis, and the large axis thereof can be substantially oriented along an average direction (nematic state). In particular, the anisotropic electric permittivity of said molecules allows to make them pivot and to orient them under the action of an electric field. The anisotropic or birefringence refraction property thereof (ordinary refraction index for a light polarised along the small axis and extraordinary refraction index for a light polarised along the large axis) further allows to modify the polarisation state of the light passing through the liquid crystal. Thus, by making the electric field applied to the liquid crystal vary, it is possible to make the polarisation of the light passing through this liquid crystal vary.

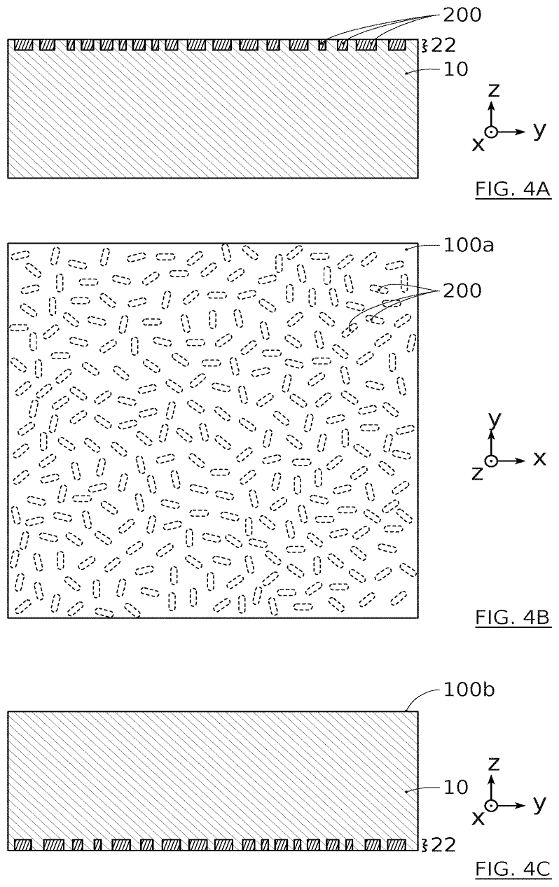

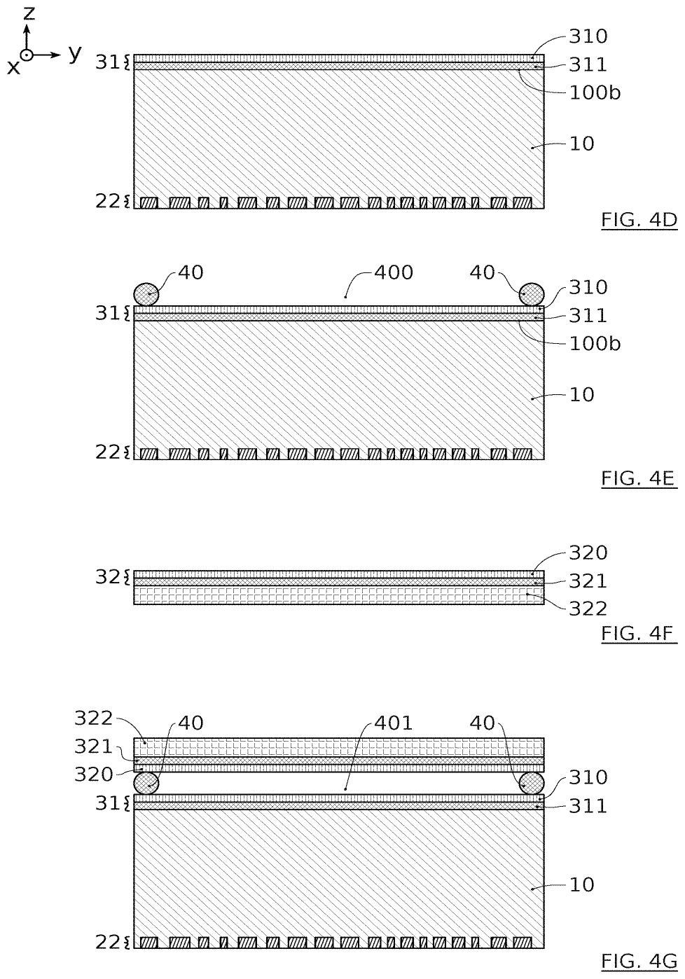

Such as illustrated in FIGS. 3A, 3B, a liquid crystal 300 can therefore be advantageously disposed within a cavity in the polarisation layer 30, between the wafers 31, 32, so as to form the modulation device. In the absence of an electric field applied to this liquid crystal, the molecules of the liquid crystal 300 have a first orientation 300a (FIG. 3A). In the presence of an electric field applied to this liquid crystal, the molecules of the liquid crystal 300 have a second orientation 300b (FIG. 3B). The light polarised by the polariser can therefore undergo a modification of the polarisation thereof by passing through the liquid crystal according to the orientation 300a, 300b of the molecules of this liquid crystal 300.

By modulating the electric field applied to this liquid crystal, the polarisation state of the light passing through it varies dynamically. If the modulation frequency f is sufficiently rapid, in particular if it is greater than the persistence of vision threshold of about 24 Hz, this modulation of the polarisation state is not detected by the observer. However, this modulation of the polarisation state advantageously allows to remove or to pixelate the favoured directions of diffusion of the light by the nanostructures 200, for the observer.

This will be thus observed, by averaging effect, a diffusion having an improved isotropy, without marked angular signature.

According to an embodiment, the liquid crystal is disposed between two parallel, horizontal wafers 31, 32. These wafers 31, 32 preferably each comprise a stack comprising an orientation layer of the liquid crystal, for example, sintered polyamide, in contact with the liquid crystal, and an electrode in the form of a transparent conductive layer, for example made of ITO (indium tin oxide). The orientation layers allow to orient the molecules along a reference direction in the main extension plane. The electrodes allow to apply an electric field to the liquid crystal and to orient the molecules along a direction of this electric field. The electrodes constitute connection means between the polarisation layer comprising the liquid crystal modulation device and a modulation system capable of generating a variable electric field.

The wafer intended to be on the side of the source (here, the wafer 32) can further be associated with a polariser preferably having a polarisation angle of 45° with respect to the reference direction. In this case, the light transmitted by the source passes through the polariser and acquires a polarisation of 45° vis-A-vis liquid crystal molecules. This polarised light will undergo a change of polarisation by rotation by passing through the liquid crystal, under the effect of the birefringence of the liquid crystal. This polarisation rotation Δϕ will depend on the thickness e of liquid crystal passed through, that is, in practice, the distance separating the two wafers, and of the deviation Δn between ordinary and extraordinary refraction indexes of the liquid crystal. It is thus possible to choose the liquid crystal (in particular, the birefringence thereof) and the thickness thereof to fix the maximum amplitude of the polarisation rotation Δϕ. In the present invention, a polarisation rotation Δϕ comprised between 15° and 90° is preferred.

To carry out such a polarisation rotation, standard liquid crystals having a deviation Δn typically comprised between 0.1 and 0.3 can suit. The thickness e can be determined from the law of delay:

e=(2·Δϕ·λ)/(2π·Δn) [Math. 1]

where λ is the wavelength of interest of the light to be polarised.

For a wavelength of 0.6 μm, a thickness e of 0.5 μm allows to obtain 15 degrees of polarisation rotation, and a thickness e of 3 μm allows to obtain 90° of polarisation rotation. The thickness e of liquid crystal is therefore preferably comprised between 0.5 μm and 3 μm.

In the absence of electric voltage between the wafers 31, 32, the liquid crystal molecules are oriented parallel to the reference direction, such as illustrated in FIG. 3A. In this case, the light polarised at 45° in the main extension plane passing through the liquid crystal along a propagation direction substantially normal to the wafers undergoes an anisotropic refraction. The polarisation thereof undergoes a rotation by passing through the liquid crystal. The initial polarisation of the light is thus modified before the light is diffused by the diffusion layer. The light is thus diffused according to a first diffusion method.

By applying a voltage typically of the order of 4 to 6 volts between the electrodes via the modulation system, the liquid crystal molecules will be oriented parallel to the electric field, in particular along the direction z normal to the wafers, such as illustrated in FIG. 3B. In this case, the polarised light passing through the liquid crystal along the propagation direction does not undergo any anisotropic refraction. The polarisation thereof does not undergo any rotation by passing through the liquid crystal. The light thus conserves the initial polarisation thereof before being diffused by the diffusion layer. The light is thus diffused according to a second method of diffusion.

By periodically modulating the voltage between the electrodes via the modulation system, at the modulation frequency f such that 20 Hz<f<200 Hz, and preferably f>24 Hz, the diffusion by the diffusion layer of the polarised light will oscillate between the two methods of diffusion, according to a plurality of methods of diffusion will dynamically generate an average diffusion. This average diffusion is advantageously isotropic for an observer.

A method for manufacturing such a diffuser is described below in reference to FIGS. 4A to 4I.

Advantageously, the standard microelectronic manufacturing means can be implemented.

On a transparent transmission layer 10 in the visible (FIG. 4A), for example, made of glass, a metal layer is deposited then structured so as to form the metal nanostructures 200 of the diffuser. This metal layer preferably has a thickness of the order of 100 nm to 500 nm. It can be made of aluminium. Such a layer is advantageously compatible with microelectronic CMOS technologies. Furthermore, aluminium has low losses by absorption. The total transmission of an aluminium nanostructure-based diffuser is optimised.

The aluminium layer is then structured in a known manner by lithography (UV or electron beam) and etching (RIE, for example).

This allows to form extended nanostructures 200, oriented and/or distributed randomly on the transmission layer 10. These nanostructures 200 are preferably distributed over the whole front face 100a of the transmission layer 10 of the diffuser (FIG. 4B). The diffusion layer 22 of the diffuser is thus formed, simply and in a minimum number of technological steps.

Optionally, a planarisation step can also be carried out.

This planarisation step comprises, for example, a deposition of a transparent material, for example silicon-based, at least between the nanostructures 200. A polishing, for example by CMP (Chemical Mechanical Polishing) can also be carried out during this planarisation step. This allows to obtain a diffusion layer 22 having a surface state compatible with possible subsequent technological steps. Such a diffusion layer 22, further has an improved mechanical strength.

The polarisation layer 30 comprising the polariser and the liquid crystal-based modulation system is then formed on the rear face 100b of the transmission layer 10.

The transmission layer 10 supporting the diffusion layer 22 is preferably returned in order to expose the rear face 100b (FIG. 4C). Optionally, a temporary protective layer can be deposited on the metal nanostructures of the diffusion layer 22 (not illustrated) so as to protect them during the following steps of manufacturing the diffuser.

A first transparent conductive layer 311, for example made of ITO (indium tin oxide), can then be deposited on the rear face 100b so as to form a first electrode of the modulation device. An optional annealing can be carried out so as to decrease the electric resistivity and to increase the transparency of this first transparent conductive layer 311.

A first orientation layer 310, for example made of sintered polyamide, can then be deposited on the first transparent conductive layer 311, so as to form a first orientation layer of the liquid crystal of the modulation device. This first orientation layer 310 can be made by depositing polyamide by centrifugation. This polyamide is then annealed, then sintered, so as to form ridges along a direction corresponding to the reference direction for the orientation of the liquid crystal.

The first transparent conductive layer 311 and the first orientation layer 310 form a first wafer 31 of the modulation device (FIG. 4D).

In order to form the cavity intended to be filled by the liquid crystal, a sealed seam 40 can be deposited on the perimeter of the first wafer 31 (FIG. 4E). According to a possibility, transparent spacers can be disposed in the space 400 delimited by the sealed seam 40 (not illustrated). In a known manner, these spacers allowing to maintain a constant separation distance between the wafers 31, 32 facing one another. This separation distance corresponds to the thickness e of liquid crystal after filling the cavity of the modulation device. The spacers also allow to reinforce mechanically the modulation device.

The second wafer 32 of the modulation device can be made separately, then assembled to the first wafer 31 via the sealed seam 40. The second wafer 32 is, for example, made in the same way as the first wafer 31, by depositing on a glass wafer 322, a second transparent conductive layer 321, for example made of ITO (indium tin oxide). A second orientation layer 320, for example made of sintered polyamide, can then be deposited on the second transparent conductive layer 321 (FIG. 4F). The treatments (annealing, sintering) possibly applied during the formation of the first wafer 31 can also be applied during the formation of the second wafer 32.

This second wafer 32 prepared separately is then returned and aligned opposite the first wafer 31, such that the first and second orientation layers 310, 320 are facing one another (FIG. 4G). The second wafer 32 is assembled to the first wafer 31 via the sealed seam 40. The cohesion of the assembly is ensured, for example, by a glue of which the refraction index does not disrupt the operation of the device for modulating the polarisation layer. This glue can be, for example, a UV glue.

The first and second wafers 31, 32 assembled via the sealed seam 40 form a cavity 401 intended to be filled by the liquid crystal. In a known manner, an opening is made through the sealed seam or the second wafer, in order to form a passage to the cavity 401. The cavity 401 is then filled by the liquid crystal 300 through this passage. A plug is then placed in the passage in order to close the cavity thus filled by the liquid crystal 300 (FIG. 4H). The modulation device 3 is thus created on the rear face of the transmission layer 10, facing the diffusion layer 22. This is configured to be subsequently connected to the modulation system via the electrodes 311, 321. This connection can be made easily through a side of the modulation device 3.

A polariser 301 can then be associated with the second wafer 32, at the level of the glass wafer 322. This polariser can be assembled or formed by deposition of polarising layer. The polarisation layer 30 comprising the liquid crystal-based 300 modulation device 3 and the polariser 301 is thus formed (FIG. 4I).

The present invention also relates to a system associating at least one light source, preferably a plurality of point light sources, with at least one diffuser such as described through preceding examples of embodiments.

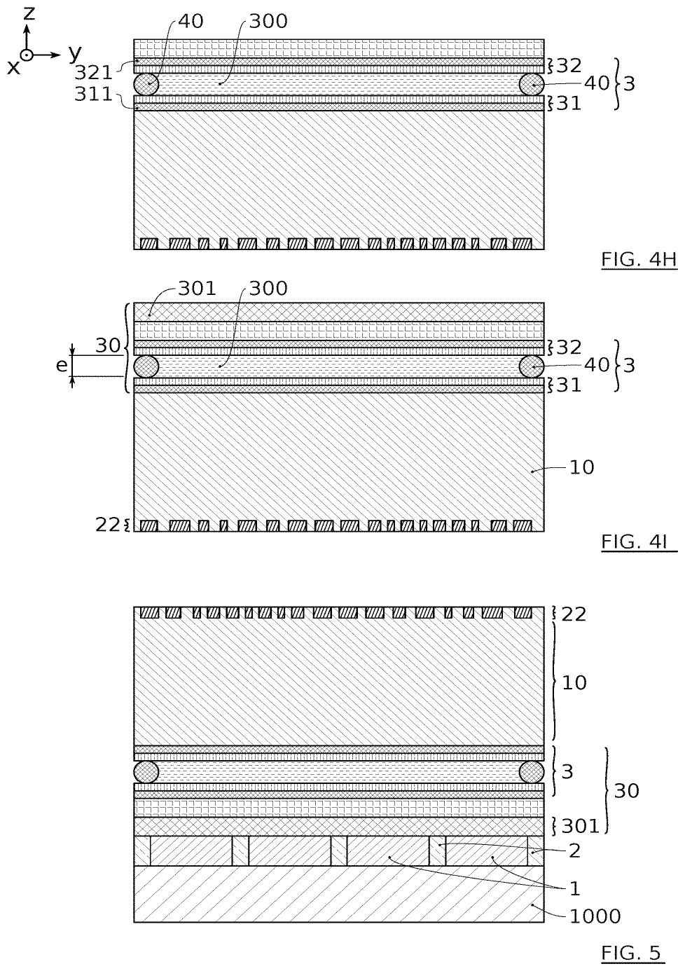

A diffuser comprising a diffusion layer 22, a transmission layer 10, a polarisation layer 30 comprising a polariser 301 and a liquid crystal-based 300 modulation device 3, such as illustrated in FIG. 4I, can in particular be arranged facing point light sources 1, for example, LEDs (FIG. 5).

The LEDs 1 can be separated from one another by electrical insulation and/or injection structures 2.

They are preferably controlled independently from one another by a control array 1000, integrating, for example CMOS (complementary metal oxide semiconductor) components.

These LEDs 1 form, for example, the pixels or the subpixels of a display screen.

The assembly between the diffuser and the plurality of point sources 1 can be done by conventional coupling with alignment, for example using a so-called “die-to-wafer” hybridisation machine.

The cohesion of the assembly is ensured, for example, by a glue of which the refraction index does not disrupt the operation of the polarisation layer. This glue can be, for example, a UV glue.

The system according to the invention associating a plurality of point light sources to at least one diffuser has an advantageous application in producing three-dimensional (3D) display screens.

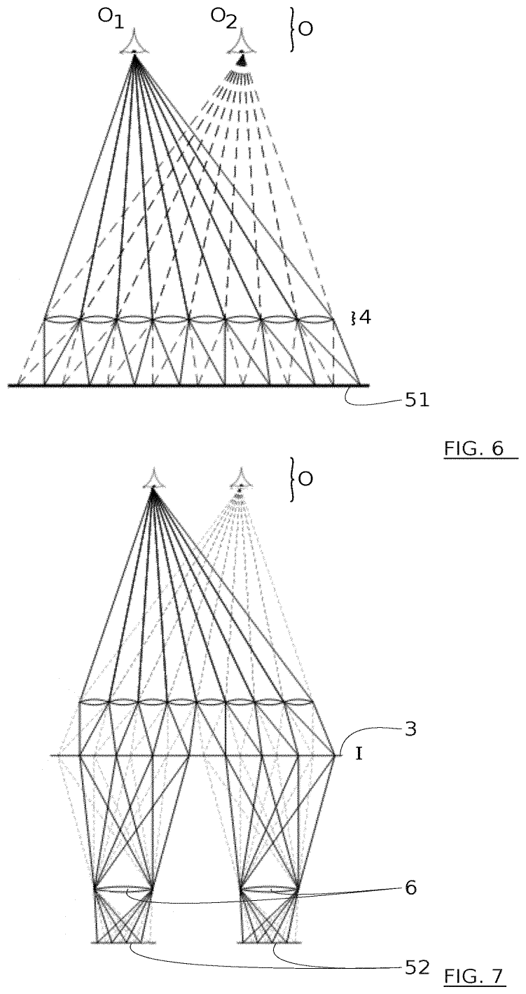

Such 3D display screen is designed so as to display slightly different images according to the view angle. In particular, to give a three-dimensional perception to an observer O, it is necessary that each of their two eyes see two slightly different images, for example in terms of luminosity and/or colour (FIG. 6).

In a known manner, a 3D screen can be made by combining a microlens array 4 and a very high-resolution screen 51, such as illustrated in FIG. 6. In such a configuration, the observer O sees the high-resolution screen 51 through the microlens array 4. In particular, the first eye of the observer O1 sees through the microlens array, a first series of small zones of the high-resolution screen, forming a first image. The second eye of the observer O2 sees through the microlens array, a second series of small zones of the high-resolution zone, forming a second image. These first and second series are intertwined within the high-resolution screen 51.

Such that the observer O can be placed arbitrarily in a given position in front of the 3D screen, the system generates different images for a multitude of viewpoints situated side-by-side. These viewpoints are commonly called “views”. At a given position, with respect to the 3D screen, the eyes O1, O2 of the observer select two different views which, by being combined, give a three-dimensional perception to the observer. When they move their head with respect to the 3D screen, this selection changes, which increases the 3D perception more.

In practice, the small zones of the different series correspond to pixels of the very high-resolution screen 51. These pixels form point light sources. They can be constituted by one or more LEDs 1, for example. The number of pixels of the very high-resolution screen is, in the case of an application to the 3D display, the sum of the number of microlenses 4 (corresponding to the nominal resolution of the 3D screen perceived by the observer) multiplied by the number of views (corresponding to the possible placements of the observer vis-A-vis the 3D screen). For one same nominal resolution, the number of pixels necessary to produce a 3D screen is therefore a lot greater than that of a 2D screen, due to the number of views. Such a system therefore requires to use a very high-resolution internal screen 51, to ultimately obtain the desired nominal resolution as a 3D display. A very high-resolution screen 51 typically has a density of pixels greater than or equal to 500 ppi (pixels per inch), and/or a pixel pitch less than or equal to 50 μm. A very high-resolution screen 51 typically has a number of pixels greater than or equal to 10 Mp (megapixels, that is 10 pixels).

This very high-resolution internal screen 51 intertwining a plurality of images associated with the number of desired views can be done or replaced with a plurality of internal micro-screens 52, each diffusing some of the images required. In this case, each of the micro-screens 52 is associated with a projection system 6. FIG. 7 illustrates such a system associating micro-screens 52 and projection systems 6. For reasons of clarity, only two micro-screens 52 and two projection systems 6 are illustrated in this FIG. 7.

Such that the light beams coming from the edges of a micro-screen 52 are directed in the direction of the observer O, it is necessary to place a diffuser in the image plane I conjugated with the plane wherein the micro-screen 52 is located.

Such a diffuser must be effective on the scale of the pixels of the very high-resolution screen 51 or pixels of the plurality of micro-screens 52. These pixels typically have a size of about 15 μm. The diffuser described in the present invention advantageously allows to obtain the effectiveness required in the scope of this application for the 3D display.

Subsequently, a system according to the invention comprising:
a. a very high-resolution screen 51 constituted of a plurality of micro-screens 52, each comprising a plurality of pixels,
b. a plurality of projection systems 6 associated with the plurality of micro-screens 52,
c. at least one diffuser such as described by the present invention, associated with each pixel of the pluralities of pixels of the micro-screens 52, and
d. a microlens array 4,
   is particularly advantageous for the 3D display.

An example of the sizing of such a system is described below.

For a 3D screen size of 195 mm×150 mm of diagonal 246 mm (9.6 inches) displaying a resolution of 1300×1000, the pitch perceived by the user is 150 μm (which corresponds to the size of a microlens 4 from the microlens array). To obtain 10×10 views, the very high-resolution screen 51 must thus have 13000×10000 pixels, with a pitch of 15 μm. Each pixel thus has a size of about 15 μm.

The very high-resolution screen 51 can be made, in practice, by assembling 5×5 micro-screens 52, each having 2600×2000 pixels. Such micro-screens 52 are, for example, commercialised by the company microOLED.

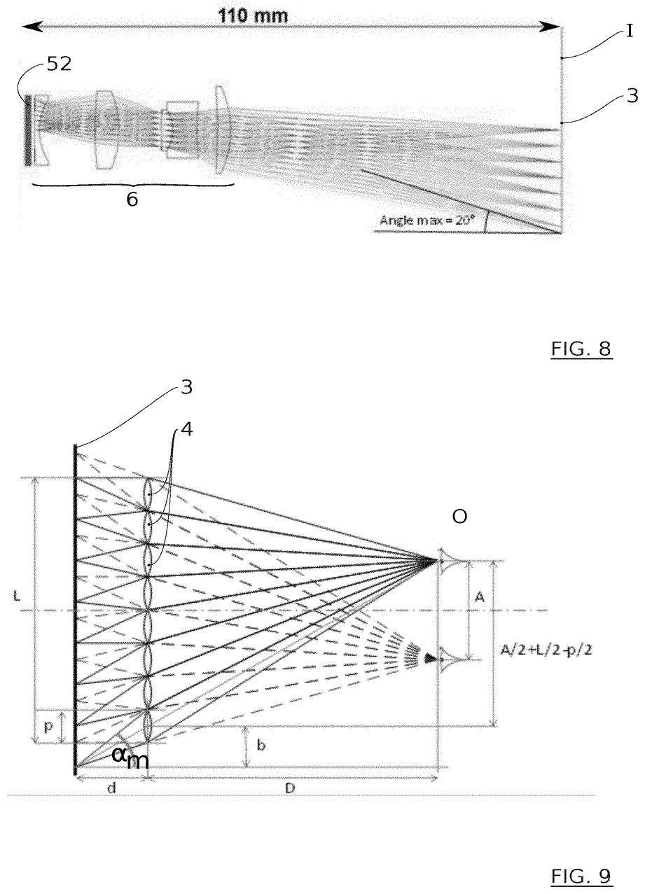

The projection system 6 can be made according to the optical design illustrated in FIG. 8. It allows, for example, to form an image of the micro-screen 52 on an image plane I situated at 110 mm from the micro-screen 52. The maximum angle of incidence P is, in this case, about 20° with respect to the normal to the image plane I. The diffuser according to the invention can effectively transmit an incident light having such an angle of incidence of the order of 20°.

The image formed on the image plane I is thus diffused by the diffuser, then focused by the microlens array 4.

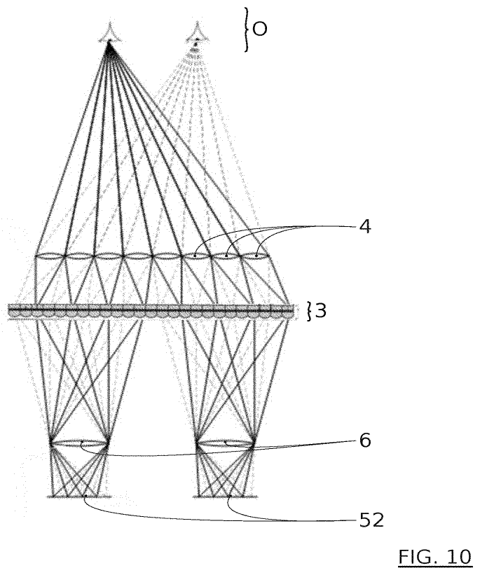

Such as illustrated in FIG. 9, for a screen of width L and for an observer situated at a distance D having eyes spaced from A, the maximum angle αₘ admissible by the microlenses 4 can be approximately determined by:

[Math 2]

$$tan {α}_{m} \approx \frac{A + L / 2}{D}$$

That is, for L=195 mm (typical width of a tablet), D=50 cm (typical observation distance of a tablet) and A=10 cm, αₘ≈21.5°.

The angles α and β are opposite signs. The diffuser is therefore configured so as to have an angular diagram having a maximum diffusion angle of about 40°. The diffuser according to the invention allows to obtain such an angular diagram.

An operational and effective 3D display system can therefore advantageously be made by benefiting from the diffuser described in the present invention, such as illustrated in FIG. 10.

The invention is not limited to the embodiments described above, and extends to all the embodiments covered by the claims.

1. A diffuser, comprising:
a transmission layer and
a diffusion layer for diffusing a light transmitted by a visible light source,
wherein the diffusion layer comprises a plurality of metal nanostructures, each of the metal nanostructures having, in projection in a main extension plane:
a longitudinal dimension corresponding to the largest dimension of the metal nanostructure according to the projection, the longitudinal dimension extending along a longitudinal axis and,
a transverse dimension taken along a transverse axis perpendicular to the longitudinal axis, the transverse dimension being less than the longitudinal dimension and being less than 650 nm,
and
the metal nanostructures are further distributed within the diffusion layer such that the longitudinal axes of at least two adjacent metal nanostructures are non-parallel.

2. The diffuser of claim 1, wherein the longitudinal axes of the metal nanostructures are oriented along a plurality of different orientations in the main extension plane.

3. The diffuser of claim 1, wherein the longitudinal and transverse dimensions are such that L≥k*1, with k=1.5.

4. The diffuser of claim 1, wherein, for at least some of the at least two adjacent metal nanostructures, the longitudinal axes of the at least two adjacent metal nanostructures form an angle α of at least 40°.

5. The diffuser of claim 1, wherein, for a given metal nanostructure, at least several metal nanostructures adjacent to the given metal nanostructure have a longitudinal axis non-parallel to that of the given nanostructure.

6. The diffuser of claim 1, further comprising:
a polarisation layer configured to polarise the light and intended to be diffused by the plurality of metal nanostructures.

7. The diffuser of claim 6, wherein the polarisation layer comprises a polariser.

8. The diffuser of claim 6, wherein the polarisation layer comprises a liquid crystal.

9. The diffuser of claim 6, wherein the polarisation layer is configured so as to dynamically modulate a polarisation of a light transmitted according to a modulation frequency.

10. The diffuser of claim 9, wherein the modulation frequency is comprised between 20 Hz and 200 Hz.

11. The diffuser of claim 1, wherein the longitudinal dimension is comprised between 200 nm and 2 μm, and the transverse dimension is comprised between 50 nm and 500 nm.

12. The diffuser of claim 1, wherein the metal nanostructures have, in projection in the main extension plane, a shape taken from among an ellipse and a rectangle.

13. The diffuser of claim 1, having, in the main extension plane, a main extension dimension D comprised between 5 μm and 30 μm.

14. The diffuser of claim 1, wherein at least some of the metal nanostructures are made of at least one metal selected from the group consisting of aluminium, tungsten, copper, silver and gold.

15. A display system, comprising:
the diffuser of claim 1, and
a point light source,
wherein the diffuser is configured to cooperate with the point light source so as to diffuse a light transmitted thereby.

16. The display system of claim 15, further comprising:
a screen comprising a plurality of micro-screens each comprising a plurality of pixels,
a plurality of projection systems associated with the plurality of micro-screens, and
a microlens array associated with the diffuser, wherein the diffuser is associated with at least one pixel of the pluralities of pixels of the micro-screens.

17. A method for manufacturing a diffuser comprising a diffusion layer for diffusing a light transmitted by a visible light source and a plurality of metal nanostructures, the method comprising:
providing a transmission layer made of a material transparent to the light transmitted, and having a front face, and
forming on the front face, the plurality of metal nanostructures, each of these metal nanostructures having, in projection in a main extension plane, a longitudinal dimension corresponding to the largest dimension of the metal nanostructure according to the projection, the longitudinal dimension extending along a longitudinal axis, and a transverse dimension taken along a transverse axis perpendicular to the longitudinal axis, the transverse dimension being less than the longitudinal dimension and being less than 650 nm, the metal nanostructures further being distributed within the diffusion layer such that the longitudinal axes of at least two adjacent metal nanostructures are non-parallel.

18. The method of claim 17, further comprising:
forming a polarisation layer on a rear face of the transmission layer,
wherein the polarisation layer is configured to polarise the light intended to be diffused by the metal nanostructures.

19. The method of claim 18, wherein the forming the polarisation layer comprises forming a cavity, and
filling of the cavity with a liquid crystal.

20. The method of claim 19 further comprising:
forming electrodes around the cavity,
wherein the electrodes are configured to apply an electric field to the liquid crystal and to electrically connect the polarisation layer to a modulation system configured to engage with the diffuser, in order to dynamically modulate a polarisation of the light polarised by the polarisation layer according to a modulation frequency.
